(19) United States
(12) Patent Application Publication
(10) Pub. No.: US 2015/0294283 A1
(43) Pub. Date: Oct. 15, 2015

(54) PERSONAL IDENTIFICATION VALIDATOR AND METHOD

(71) Applicant: JCM American Corporation, Las Vegas, NV (US)

(72) Inventor: Robert J Siemasko, Las Vegas, NV (US)

(73) Assignee: JCM American Corporation, Las Vegas, NV (US)

(21) Appl. No.: 14/249,383

(22) Filed: Apr. 10, 2014

(51) Int. Cl. G06Q 20/10; G06K 9/00; G06F 17/30

(52) U.S. Cl. CPC G06Q 20/1085; G06F 17/3028; G06K 9/00442

(57) ABSTRACT

A banknote validator integrated into an automated machine having a personal identification data collection apparatus and method integrated therein. The system utilizes the banknote image acquisition device, a separate image acquisition device, a computer readable data storage reader and/or an external personal identification data acquisition member for obtaining information from a personal identification reference, such as a state identification card. The system can utilize the personal identification data to determine if the individual is authorized to or restriction from use of the automated machine, provide security to operation of the machine, and create and utilize a relationship between the individual associated with the personal identification and other cards (such as financial cards, facility related cards, etc.) for use in a transaction.

### FIELD OF INVENTION

This invention relates to an automated machine bill or note validator comprising a personal identification system integrated therein. More specifically, the validator incorporates at least one capture image sensor (CIS) and associated processing circuitry and software being utilized for both Personal Identification recording as well as bill image recognition and validation.

### BACKGROUND OF THE INVENTION

Automated vending machines utilize automated cash handling systems to accomplish financial transactions. One component of the automated cash handling system is a banknote acceptor (commonly referred to as bill or note validators).

Banknote acceptors include currency handling equipment and optical and magnetic sensors for transporting and scanning paper currency. Digital logic circuitry obtains an image obtained from the optical and magnetic sensors to determine a value and authenticity of the deposited note. Once the banknote is validated, the bill validator informs a vending machine controller (VMC) or other host device to apply and tally a credit for use by the individual.

Security at automated machines is generally limited to a digital video camera. The camera is directed towards a location designed to be occupied by the individual using the machine. A process of obtaining an image of an individual utilizing the machine has an inherent limitation. The photographic image does not provide details of who the individual is, where they reside, and the like. The photographic image can only be utilized in publicity to help others initially identify the individual.

Automated vending machines are generally available for use by any individual. Use of certain automated vending machines are often subjected to age restrictions. Automated vending machines that are subjected to age restrictions are generally not monitored and enforcement of the age restriction has primarily been relegated by compliance with an honor system.

An object of the present invention is to provide a personal identification acquisition system that obtains personal information respective to the individual using the machine. Another object of the present invention is to provide a method of approving or denying use of the automated vending machine by the individual based upon predetermined criteria.

### BRIEF SUMMARY OF THE INVENTION

The electronic payment system according to the present invention comprises a payment system for use in conjunction with automated point of sale machines, including automated vending machines, automated gaming machines, and the like. The payment system enables completion of a financial transaction using an automated payment system integrated into the automated gaming machine. The automated payment system is additionally adapted to obtain and decipher an image of a personal identification card or other personal identification form factor.

In accordance with one embodiment of the present invention, the invention includes a method of obtaining information respective to an individual using an automating transaction machine from a personal identification reference, the method comprising the steps:

presenting the personal identification reference to an image acquisition device integrated into a banknote acceptor of an automated machine having an automated financial transaction system integrated therein, the banknote acceptor comprising:
an insertion slot defined between a lower transport element and an upper transport element,
a microprocessor in signal communication with the image acquisition device,
a signal communication interface providing signal communication between the microprocessor and at least one personal identification database server containing a personal identification database; and

obtaining a digital image of the personal identification reference, wherein the step is accomplished by the image acquisition device integrated into the banknote acceptor;

and at least one of:

storing information obtained from the digital image of the personal identification reference in the personal identification database on one or more of the at least one personal identification database servers, and

obtaining images from the personal identification database and comparing the digital image of the personal identification reference with images from the personal identification database to determine a match.

In second aspect, the personal identification reference comprises at least one photographic image of the individual and text associated with the individual. The associated text can include any or all of the following:

Issuing agency of the personal identification reference,

Individual's last name,

Individual's first name,

Individual's street address,

Individual's region address information, such as city, state and zip code,

Individual's date of birth,

Individual's sex,

Individual's height,

Individual's weight,

Individual's eye color,

Personal identification reference issue date, and

Personal identification reference expiration date.

In another aspect, the personal identification reference can be restricted to an authorized group of personal identification references. The group of personal identification references can include:

State issued identification card,

State issued driver's license,

Federally issued visa,

Federally issued work cards, and

any other acceptable Federally or State issued personal identification reference(s).

In another aspect, the personal identification reference can include a computer readable data storage element. The computer readable data storage element can be a magnetic strip, an electro-mechanically engaging embedded electronic information storage device, a passive wireless communicating system, such as Radio Frequency Identification (RFID), and the like.

In yet another aspect, the method further comprises a step of converting text provided on the personal identification reference to at least one character string using the microprocessor in accordance with an optical character recognition process.

In yet another aspect, the system further comprises a step of comparing the personal identification reference with data obtained from a certified database. The certified databases can be a government database, a preapproved supplemental database, and the like.

In yet another aspect, the automated point of sale machine further comprises a security camera.

In yet another aspect, the system further comprises a step of capturing an image of an individual using the automated point of sale machine and comparing that image with an image included on the personal identification reference.

In yet another aspect, the method further comprises a step of associating the personal identification reference with a different personal identification reference.

In yet another aspect, the method further comprises a step of associating the personal identification reference with facility or corporation related card or account, such as a gaming player's card, a rewards card, and the like.

In yet another aspect, the method further comprises a step of obtaining an association between the personal identification reference and the facility or corporation related card or account and utilizing the association to complete an operation accordingly.

In yet another aspect, the method further comprises a step of associating the personal identification reference with a financial transaction card or account, such as an Automated Teller Machine (ATM) card, a credit card, an electronic account, an electronic wallet, an ecommerce account, and the like.

In yet another aspect, the method further comprises a step of obtaining an association between the personal identification reference and the financial transaction card or account and utilizing the association to complete a financial transaction.

In yet another aspect, the method can further comprise a step of determining if the associated person is excluded from operation of the automated point of sale machine.

In yet another aspect, exclusion can be determined by legal restrictions, including legal age restrictions, legal judgment restrictions, and the like. Government restrictions can include broad based state and/or federal legislation (such as age restrictions), Federal judgments, State judgments, probationary restrictions, conviction based exclusions, and the like.

In yet another aspect, exclusion can be determined by ethical restrictions, including those with identified gambling addictions, self-admitted restrictions, and the like.

In yet another aspect, the automated point of sale machine can communicate with other automated point of sale machines to control operation of the other automated point of sale machines by the individual. The individual can be subsequently identified by associating the personal identification reference with an image obtained by the automated machine security camera.

In yet another aspect, the image acquisition device can be utilized to scan both notes and the personal identification reference.

In yet another aspect, the image acquisition device can be integrated into an external portion of the banknote validator.

In yet another aspect, the image acquisition device can be integrated into an external hood extending forward from the banknote validator.

These and other aspects, features, and advantages of the present invention will become more readily apparent from the attached drawings and the detailed description of the preferred embodiments, which follow.

### BRIEF DESCRIPTION OF THE DRAWINGS

The above-mentioned and other objects and advantages of the present invention will be apparent from the following description in connection with the accompanying drawings showing gaming machines as preferred embodiments of the electronic payment system of the invention wherein:

FIG. 1 presents an isometric view of an exemplary banknote validator integrated into an exemplary automated point of sale machine;

FIG. 2 presents a cross sectioned elevation view of the banknote validator introduced in FIG. 1;

FIG. 3 presents a schematic diagram introducing functional components of the banknote validator being adapted for use as capture image scanner (CIS) to obtain an image of a personal identification reference and the utilization of the acquired image;

FIG. 4 presents a plan view of an exemplary personal identification reference;

FIG. 5 presents a process flow diagram illustrating an exemplary personal identification reference acquisition and validation process;

FIG. 6 presents a process flow diagram illustrating an exemplary personal identification reference exclusion investigation process;

FIG. 7 presents a schematic diagram illustrating an exemplary personal identification reference exclusion investigation process;

FIG. 8 presents a schematic diagram illustrating an exemplary personal identification and facility or corporation related card or account association process; and

FIG. 9 presents a presents a schematic diagram illustrating an exemplary personal identification and facility or corporation related card or account association process.

Like reference numerals refer to like parts throughout the several views of the drawings.

### BEST MODE FOR CARRYING OUT THE INVENTION

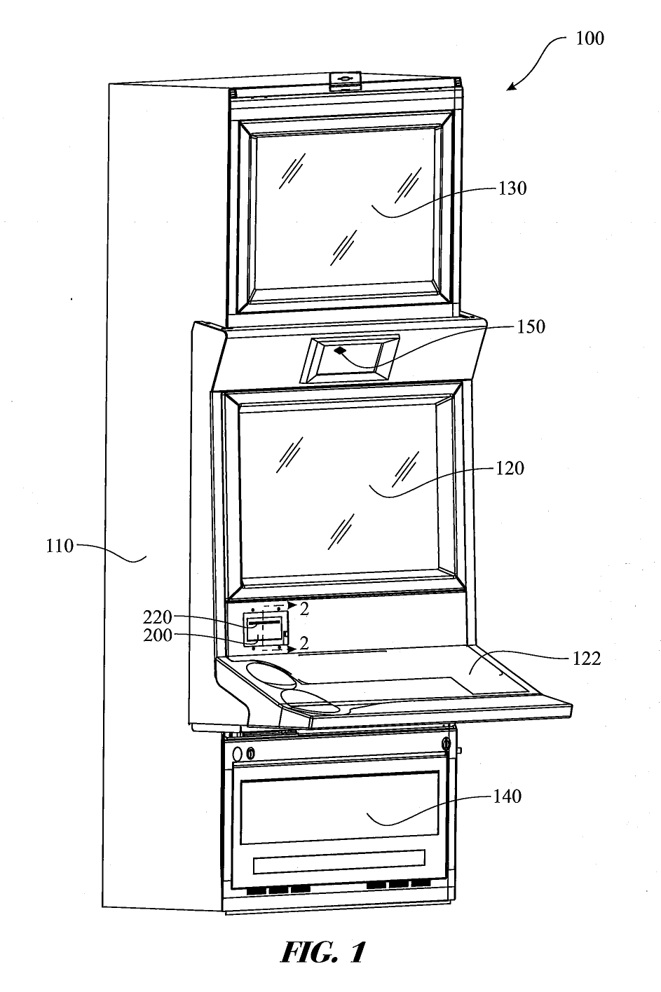

Automated point of sale systems are integrated into a variety of automated point of sale machines, including gaming machines 100 (as shown in the exemplary illustration in FIG. 1), vending machines, and the like. The exemplary automated point of sale machine 100 is an automated gaming machine 100, which includes various elements enabling a casino or other facility to attract players to the automated point of sale machine 100, enable a player to enjoy use of the automated point of sale machine 100 and monitor play on the automated point of sale machine 100. The various functional elements are installed within a machine cabinet 110. The machine cabinet 110 provides an external structure and any internal structure employed for supporting and attachment of the elements of the automated point of sale machine 100 therein. The functional components include a gaming machine visual interface 120 and gaming machine tactile interface 122, which provide interaction between the automated point of sale machine 100 and the player. The gaming machine visual interface 120 and gaming machine tactile interface 122 would be ergonomically configured for use by the player. Operational components, including at least one game controller, a power distribution circuit, and the like are integrated into the machine cabinet 110, wherein the operational components are accessed through and represented by an operational cabinet access 140. A gaming machine promotion display 130 is located at an uppermost portion of the automated point of sale machine 100 proving optimal viewing to attract potential players passing by to the automated point of sale machine 100. The gaming machine promotion display 130 commonly displays the machine name, the current jackpot value, and the like. A machine security camera 150 can be integrated into the automated point of sale machine 100 at a location to obtain images of the player during play and other activities in the general vicinity of the machine. The machine security camera 150 records a series of digital images in either still images or video format. The recorded images are most commonly used for security purposes.

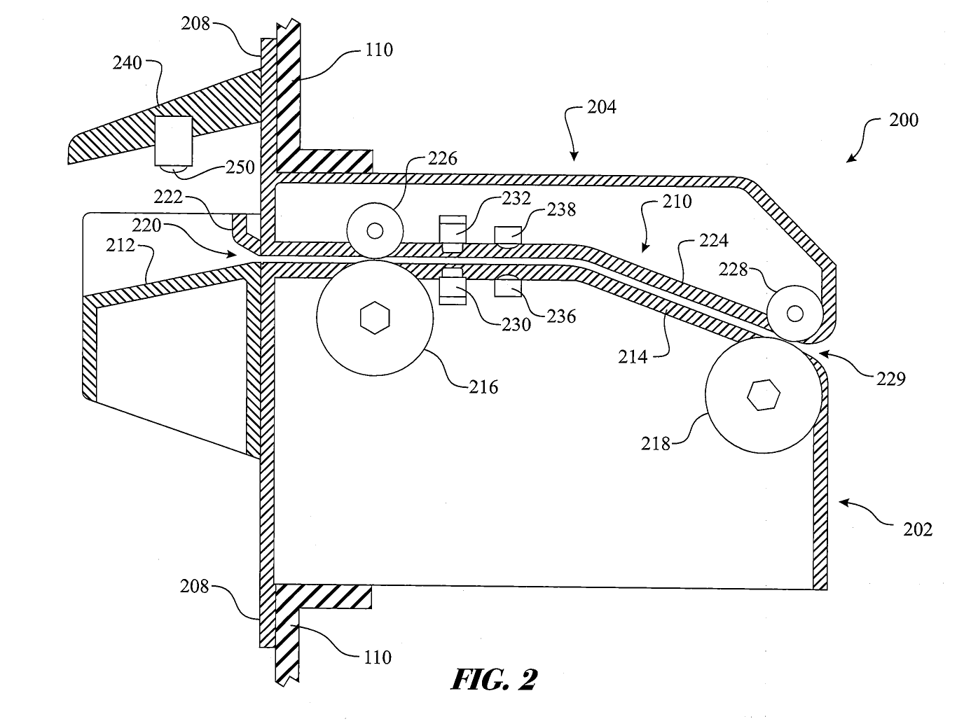

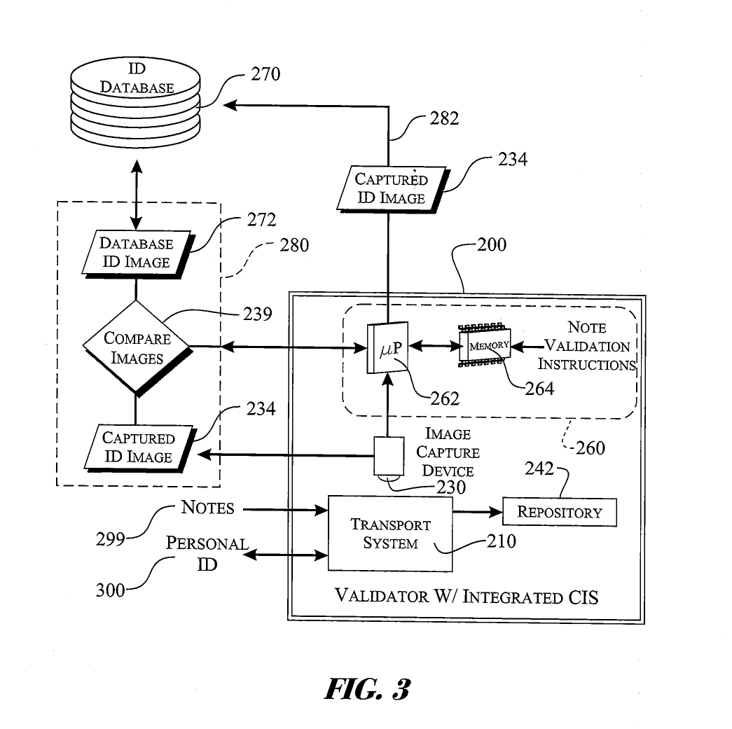

The automated point of sale machine 100 includes an automatic financial transaction processing system comprising a bill validator 200. Details of the bill validator 200 are presented in a cross sectional view illustrated in FIG. 2 and an associated schematic diagram presented in FIG. 3. The bill validator 200 includes a validator lower frame section 202 and a validator upper frame section 204. A mounting flange 208 surrounds a forward peripheral portion of the bill validator 200. The bill validator 200 is assembled to the machine cabinet 110 by inserting the bill validator 200 through an aperture formed through the machine cabinet 110. In the exemplary embodiment, the bill validator 200 is assembled to the machine cabinet 110 by inserting a rear or internal portion of the bill validator 200 through the aperture, seating the mounting flange 208 against an exterior surface of the machine cabinet 110. The validator lower frame section 202 can include a note lower guide member 214. The validator upper frame section 204 can include a note upper guide member 224. A transportation passageway is defined between the note lower guide member 214 and the note upper guide member 224. An entryway for the bill validator 200 includes a note lower insertion guide 212 in registration with the note lower guide member 214 and a note upper insertion guide 222 in registration with the note upper guide member 224. Each of the note lower insertion guide 212 and note upper insertion guide 222 include extension elements being formed having diverging ends which define a lead-in directing insertion of a discharge slot 229 or a personal identification 300 into an insertion slot 220 provided therebetween. The insertion slot 220 is defined between an entry or insertion end of the note lower insertion guide 212 and the note upper insertion guide 222. A discharge slot 229 is defined between an exit or discharge end of the note lower guide member 214 and the note upper guide member 224.

Transport of the notes 299 and personal identification 300 along the guides 214, 224 is provided by a series of transportation elements 216, 218, 226, 228. In the exemplary embodiment, the transportation elements are arranged in opposing pairs, more specifically an intake lower note transport element 216 and an intake upper note transport element 226 and a storage lower note transport element 218 and a storage upper note transport element 228. Each pair of transportation elements (216, 226), (218, 228) pinches the inserted object and draws the inserted object into the bill validator 200, passing the image acquisition device(s) 230, 232. Although the exemplary transportation elements 216, 218, 226, 228 are in a form factor of a friction wheel or friction drum, it is understood that the transportation elements 216, 218, 226, 228 can be provided in any suitable form factor including a tread, a spiked wheel, and the like.

Image acquisition devices 230, 232 can be installed at any position along the guide member 214, 224. The bill validator 200 can include a lower image acquisition device 230, an upper image acquisition device 232, or both. The bill validator 200 should indicate the acceptable orientation or orientations for insertion of the note 299 or personal identification 300, wherein the orientation is determined by the inclusion, the location and the read direction of the image acquisition devices 230, 232.

The note 299 is inserted into the insertion slot 220, travels between the note lower guide member 214 and note upper guide member 224 and is discharged through the discharge slot 229. The discharged notes 299 are collected in a repository 242. The note transportation system 210 can optionally include a transportation controller and direct notes 299 that are not authenticated into a second repository 242 designated to collect notes having questionable authenticity. The personal identification 300 is inserted into the insertion slot 220, travels between the note lower guide member 214 and note upper guide member 224 until desired information is obtained from the personal identification 300 by the lower image acquisition device 230 and/or upper image acquisition device 232. Once the information is acquired from the personal identification 300, the transportation system reverses a direction of travel and discharges the personal identification 300 through the insertion slot 220; returning the personal identification 300 to the Individual.

The bill validator 200 includes a Printed Circuit Assembly (PCA) 260 integrates a microprocessor 262 and a digital memory device 264 into an operational control circuit. The microprocessor 262 obtains data from the lower image acquisition device 230 and upper image acquisition device 232 through a signal communication link provided therebetween. The microprocessor 262 and digital memory device 264 are in signal communication with one another via communication links provided by circuitry of the Printed Circuit Assembly (PCA) 260. The microprocessor 262 operates in accordance with an instruction set. The instruction set includes instructions for validating a scanned or acquired image of a note 299 to determine the value, type, and authenticity thereof

An external personal identification data acquisition member 250 can be integrated into an external feature, such as a front validator hood 240 of the bill validator 200. The external personal identification data acquisition member 250 can be included in addition to the internally configured scanning devices or as an alternative thereto. The external personal identification data acquisition member 250 would be in signal communication with the microprocessor 262. It is also understood that the bill validator 200 can include a plurality of external personal identification data acquisition members 250, including assembly of an external personal identification data acquisition member 250 to the note lower insertion guide 212 or any other suitable location of the bill validator 200. The external personal identification data acquisition member 250 can be an image acquisition device, a computer readable data storage reader, or a combination thereof.

Functional operation of an instruction set associated with the bill validator 200 is described in FIG. 3. One or more image acquisition devices 230, 232 are employed to acquire one or more images of an object during transport along the note transportation system 210. The image acquisition device(s) 230, 232 obtains a captured personal identification image 234 and subsequently conveys the captured personal identification image 234 to the microprocessor 262. The microprocessor 262 includes a data instruction set defining an image storage conveyance step 282 that conveys the captured personal identification image 234 to an identification database 270 for data retention. The identification database 270 can determine if the captured personal identification image 234, an earlier version of the captured personal identification image 234, or an associated captured personal identification image 234 had been previously stored and would act accordingly. In a condition where the captured personal identification image 234 was not previously stored, the identification database 270 would index and store the captured personal identification image 234. In a condition where the captured personal identification image 234 was previously stored, the identification database 270 would transmit a respective signal to the microprocessor 262, which in turn, would inform the facility, the user, and/or the like of the stored status. In a condition where a previous version of the captured personal identification image 234 was stored, the identification database 270 would transmit a respective signal to the microprocessor 262, which in turn, would inform the facility, the user, and/or the like of the stored status. The microprocessor 262 could offer the individual, the facility, both, or any other associated party with an option to store both versions, overwrite the older version, retain the older version, or offer any other suitable solution.

The microprocessor 262 additionally includes a data instruction set defining an image comparison process 280 that obtains one or more reference images 272 from the identification database 270 and compares each reference image 272 with the captured personal identification image 234 to determine a match. One or more reference images 272 can be associated with information that would be useful for the automated point of sale machine 100. Should the image comparison step 239 determine a match between a database identification image 272 and a captured personal identification image 234, the microprocessor 262 can utilize a reference associated with the matching database identification image 272 to obtain any information associated with the respective database identification image 272. The microprocessor 262 would then submit directions to the automated machine controller based upon the information associated with the respective database identification image 272. In turn, the automated machine controller would act accordingly.

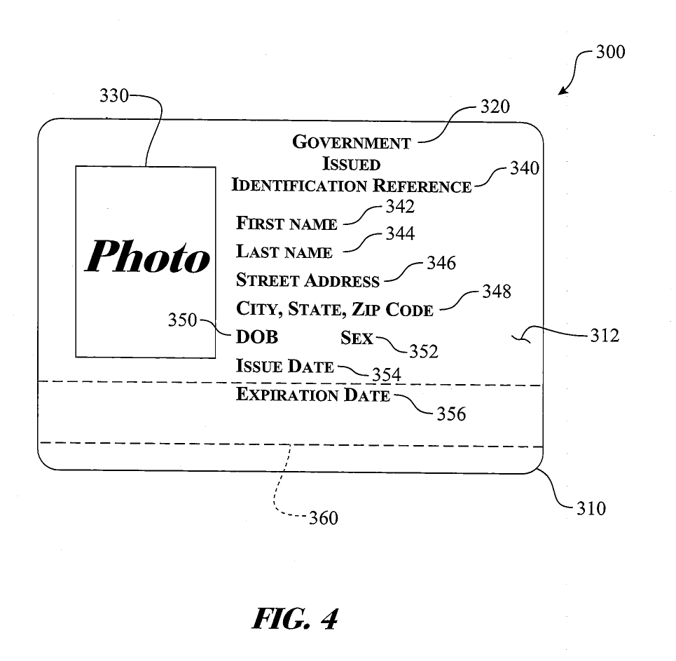

Details of an exemplary personal identification 300 are introduced in an exemplary schematic layout presented in FIG. 4. The bill validator 200 includes images applied to at least one personal identification data surface 312 of a personal identification substrate 310. The following provides a list of potential elements presented on a personal identification 300:

an issuing agency of the personal identification reference 320,

a photographic image of the Individual 330,

an Individual's first name 342,

an Individual's last name 344,

an Individual's street address 346,

an Individual's region address information, such as city, state and zip code 348,

an Individual's date of birth 350,

an Individual's sex 352,

an Individual's height (not illustrated),

an Individual's weight (not illustrated),

an Individual's eye color (not illustrated),

a personal identification reference issue date 354, and

a personal identification reference expiration date 356.

A computer readable data storage element 360 can be integrated into the personal identification 300. The exemplary computer readable data storage element 360 is an encoded magnetic strip. The magnetic stripe would be encoded with at least a portion of the information displayed upon the personal identification 300. At least one associated computer readable data storage reader 236, 238 (FIG. 3) would be integrated into the bill validator 200. It is understood that the computer readable data storage element 360 can be provided in any suitable computer readable data storage format, including an electro-mechanically engaging embedded electronic information storage device, a passive wireless communicating system, such as Radio Frequency Identification (RFID), and the like. The digital information storage options would digitally store at least a portion of the information displayed upon the personal identification 300 within a memory portion thereof. The associated computer readable data storage reader 236, 238 would read the information stored upon the computer readable data storage element 360.

The bill validator 200 can include a both the image acquisition device 230, 232 and the computer readable data storage reader 236, 238 enabling scanning and acquisition of the personal photograph 330 and computer retrieval of information stored upon the computer readable data storage element 360. This configuration provides a solution that eliminates a need for optical character recognition software. In another configuration, the image acquisition device 230, 232 would scan the personal photograph 330 and respective text displayed upon the personal identification 300. The computer readable data storage reader 236, 238 would retrieve the information digitally stored on the computer readable data storage element 360. The microprocessor 262 would convert the information obtained by the scan of the respective text displayed upon the personal identification 300 to a character format using the optical character recognition instruction set. The microprocessor 262 could then compare the information digitally obtained by the computer readable data storage reader 236, 238 with the optical character recognized information obtained from the scan of the respective text displayed upon the personal identification 300. This configuration provides an improved probability for determining authenticity of the personal identification 300.

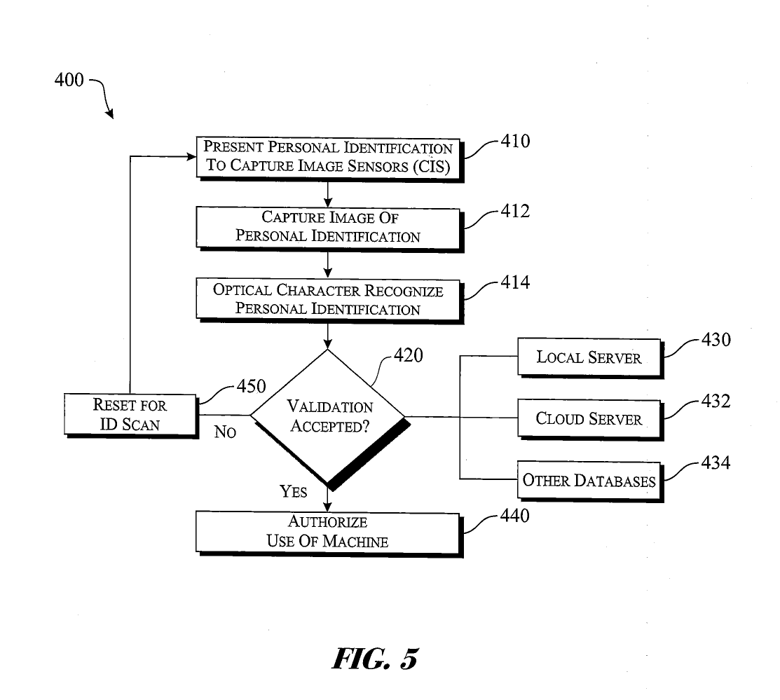

Another method for validating the personal identification 300 can be accomplished by communicating with one or more databases comprising information for authenticating the personal identification 300, as illustrated in the exemplary personal identification reference acquisition and validation process 400 presented in FIG. 5. The personal identification 300 is presented to the image acquisition devices 230, 232 using the note transportation system 210 in accordance with a personal identification presentation step 410. Information displayed upon the personal identification data surface 312 of the personal identification 300 is acquired by one or more of the image acquisition devices 230, 232 in accordance with a personal identification image acquisition step 412. The microprocessor 262 converts the information obtained by the scan of the respective text displayed upon the personal identification 300 to a character format using the optical character recognition instruction set in accordance with an optical character recognition step 414. The microprocessor 262 continues with a validation process. The validation process obtains authentication information from one or more databases. The exemplary databases can be stored at a local server 430, a cloud server 432, and/or any other suitable database 434. The databases can be a government established authentication database, a privately established authentication database, a locally established authentication database, and the like. The microprocessor 262 communicates with any of the available servers 430, 432, 434 to validate the personal identification 300. The microprocessor 262 compares information obtained from any of the available servers 430, 432, 434 with information obtained from the personal identification 300 to validate the presented personal identification 300 in accordance with a validate decision step 420. Once the personal identification 300 is validated, the process provides an authorization signal to the automated machine controller in accordance with an authorization of use step 440. If the personal identification 300 is determined to be suspect, the microprocessor 262 informs the individual as such and resets for a new scan, as indicated by a reset step 450.

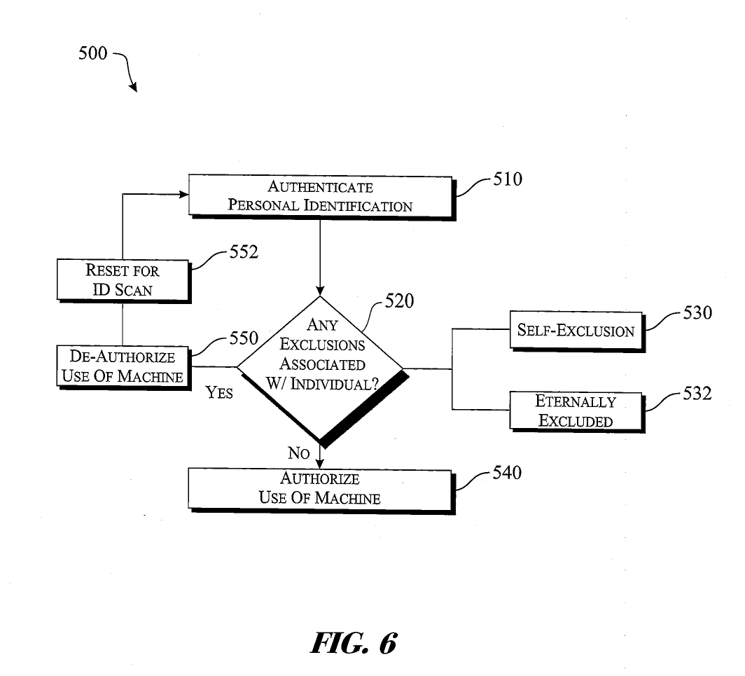

The validation process can be enhanced or modified by introducing a personal identification reference exclusion investigation process 500 as illustrated in the exemplary flow diagram presented in FIG. 6. The individual associated with the submitted personal identification 300 can have one or more exclusions for operation of the automated point of sale machine 100 based upon any of a variety of reasons. One exemplary reason would be age. Certain automated point of sale machines 100 are restricted for use or vend by legal minimum age requirements. This can be determined by utilizing established rules provided by a respective database such as an externally excluded database 532. Other externally derived restrictions can include Federal judgments, State judgments, probationary restrictions, conviction based exclusions, and the like, which can also or alternatively be included in the externally determined restrictions database 532. The system can alternatively or inclusively utilize ethical restrictions, such as those with identified gambling addictions, self-admitted restrictions, and the like, which can be stored in a self-exclusion or ethical restricting database 530.

The process initializes with the steps previously described for validating authenticity of the personal identification 300, collectively referred to as a personal identification authentication step 510. The process investigates if the individual associated with the submitted personal identification 300 has any exclusions or restrictions for operation of the automated point of sale machine 100 in accordance with an exclusions decision step 520. The process utilizes one or more exclusion databases 530, 532 as a reference for determining if the individual associated with the submitted personal identification 300 has any exclusions or restrictions established respective to operation of the automated point of sale machine 100.

Under a condition where the exclusions decision step 520 determines the individual associated with the submitted personal identification 300 has no exclusions identified for operation of the automated point of sale machine 100, the microprocessor 262 forwards a signal to the automated machine controller to enable operation of the automated point of sale machine 100 in accordance with an authorization step 540.

Under a condition where the exclusions decision step 520 determines the individual associated with the submitted personal identification 300 has exclusions regarding operation of the automated point of sale machine 100, the microprocessor 262 forwards a signal to the automated machine controller to restrict or de-authorize operation of the automated point of sale machine 100 in accordance with a de-authorization step 550. The microprocessor 262 resets the system in preparation for a new read or scan of another personal identification 300 in accordance with a scanner reset step 552.

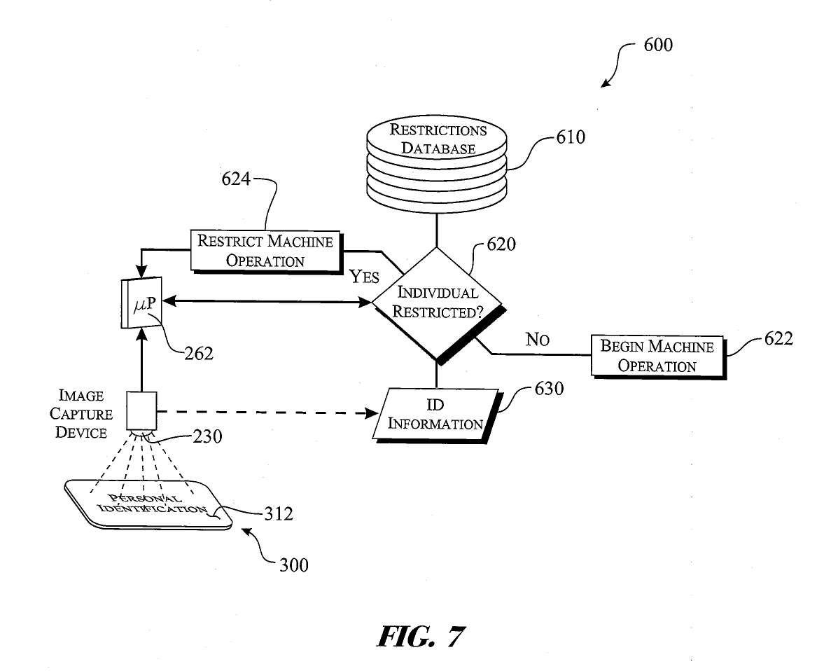

A personal identification reference exclusion investigation process 600 is illustrated in the exemplary schematic diagram presented in FIG. 7. The personal identification reference exclusion investigation process 600 is a slightly modified version of the personal identification reference exclusion investigation process 500. The image acquisition device 230, 232 (and/or the computer readable data storage reader 236, 238) obtains information from the personal identification 300, and in conjunction with the microprocessor 262, the process generates a personal identification reference acquired data image 630. The microprocessor 262 operates in accordance with a set of instructions (referred to as an individual restriction decision step 620) to determine if individual associated with the personal identification 300 is subjected to any restrictions that would be applicable to the operation of the automated point of sale machine 100. The microprocessor 262 utilizes the personal identification reference acquired data image 630 to submit an inquiry to the restrictions database 610 to draw any restrictions that are applicable either generally or specifically to the individual associated with the personal identification 300. The restrictions database 610 would include information provided by the facility, the government, the individual themselves, and the like. The restrictions database 610 could include both the ethical restricting database 530 and the externally determined restrictions database 532.

Under a condition where the individual restriction decision step 620 determines the individual associated with the submitted personal identification 300 is not subjected to any restrictions that would be applicable towards operation of the automated point of sale machine 100, the microprocessor 262 forwards a signal to the automated machine controller to enable operation of the automated point of sale machine 100 in accordance with an authorization step 622.

Under a condition where the exclusions decision step 520 determines the individual associated with the submitted personal identification 300 has restrictions that would be applicable towards operation of the automated point of sale machine 100, the microprocessor 262 forwards a signal to the automated machine controller to restrict or de-authorize operation of the automated point of sale machine 100 in accordance with a de-authorization step 624. The microprocessor 262 resets the system in preparation for a new read or scan of another personal identification 300 in accordance with a scanner reset step 552.

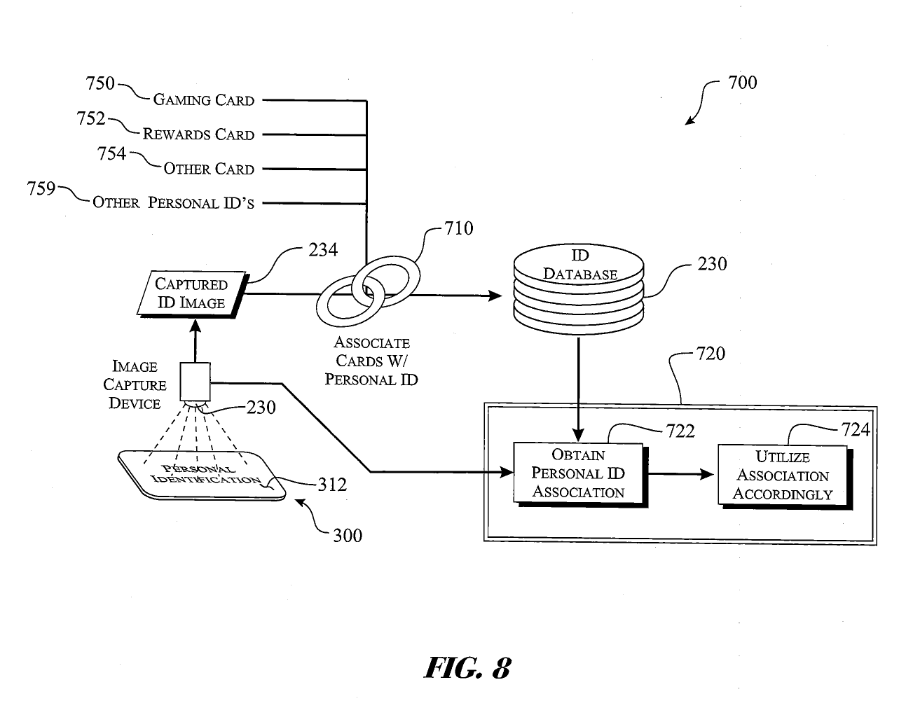

Once the information is acquired from the personal identification 300, the information can be associated with facility or corporation related card(s) or account(s), such as a gaming player's card 750, a rewards card 752, other cards 754, and other personal identification references 759, as illustrated in an exemplary schematic diagram representative of a personal reference and a facility or corporation related card or account association process 700 as presented in FIG. 8. The process initiates with a step of acquiring information from the personal identification 300. The acquisition can be accomplished using at least one of an image acquisition device 230, 232 to obtain an image from the personal identification data surface 312 and a computer readable data storage reader 236, 238 to obtain stored digital data from the computer readable data storage element 360. It is understood that any of the above-identified processes can be employed to authenticate the personal identification 300. The system can obtain information respective to any facility or corporation related card(s) or account(s), such as the gaming player's card 750, the individual's rewards card 752, other cards associated with the individual 754, and other personal identification references associated with the individual 759 from the individual, a database, and the like. The individual and/or the system can create a personal reference and a facility or corporation related card or account association 710 by providing the system with information related to the gaming player's card 750, the individual's rewards card 752, other cards associated with the individual 754, and other personal identification references associated with the individual 759. In accordance with one process, the information can be obtained by inserting the respective facility or corporation related card into the bill validator 200, wherein the readers integrated within the bill validator 200 would acquire the information form the inserted card. In accordance with another process, the system can search known databases and present facility or corporation related card information that matching at least a portion of the information obtained from the personal identification 300 to the individual. The individual would accept or reject proposed associations. This can be accomplished at the automated point of sale machine 100, through an Internet, at a facility service center, and the like. The association would be stored within any suitable database, such as an identification reference database 230, a separate association database, and the like.

The system would obtain the association between the personal identification 300 and any associated facility or corporation related card or account 750, 752, 754, as identified by a personal identification association attainment step 722. It is noted that the association eliminates a need for the individual to carry and present the facility or corporation related card or account for use. Once the microprocessor 262 has attained the association between the personal identification 300 and any associated facility or corporation related card or account 750, 752, 754, the microprocessor 262 can employ the association in any manner that would normally be accomplished as if the individual presented the facility or corporation related card or account information directly to the bill validator 200, wherein the utilization is represented by an association utilization step 724.

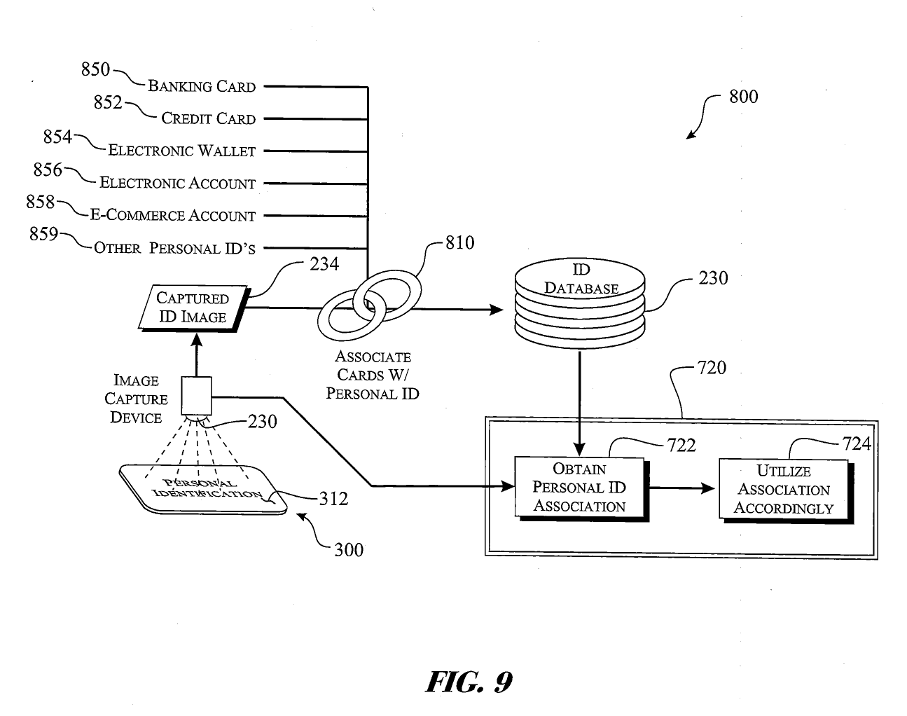

The association process can be adapted to associate a financial card or account with the personal identification 300, as illustrated in an exemplary schematic diagram representative of a personal reference and a financial card or account association process 800 as presented in FIG. 9. The process parallels the steps of the a personal reference and a facility or corporation related card or account association process 700, wherein the process establishes an association between a financial transaction card or an electronic account and the personal identification 300. Examples of financial transaction cards and electronic accounts that can be associated with the personal identification 300 include any or all of a banking card 850, credit card 852, electronic wallet 854, electronic account 856, e-commerce account 858, other personal identification references 859, and the like. The microprocessor 262 (or other transaction processing device) would utilize the association to complete a financial transaction in accordance with the association employment process 720 as previously described herein.

It is understood that the above-presented exemplary features presented above can be tailored by mixing or combining processes.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

### INDUSTRIAL APPLICABILITY

The present invention is applicable to integration of a personal identification data acquisition system and method into a banknote validator of an automated machine such as a gaming machine, an automated teller machine, a vending machine, money exchangers or any other money-operated equipment or apparatus.

What is claimed are:

1. A method of obtaining information respective to an individual using an automating transaction machine from a personal identification reference, the method comprising steps of:
presenting said personal identification reference to an image acquisition device integrated into a banknote acceptor of an automated machine having an automated financial transaction system integrated therein, said banknote acceptor comprising:
an insertion slot defined between a lower transport element and an upper transport element,
a microprocessor in signal communication with said image acquisition device,
a signal communication interface providing signal communication between said microprocessor and at least one personal identification database server containing a personal identification database; and
obtaining a digital image of said personal identification reference, wherein said step is accomplished by said image acquisition device integrated into said banknote acceptor;
converting at least a portion of said digital image into at least one character string, wherein said converting step is accomplished by said microprocessor in accordance with a set of associated conversion instructions; and
digitally storing said at least one character string is a database located on a server through a communication link provided between said microprocessor and said server.

2. The method of obtaining information respective to an individual using an automating transaction machine from a personal identification reference as recited in claim 1, further comprising a step of:
digitally storing at least one of an electronic image of said personal information reference and a photographic image displayed upon said personal information reference on said server.

3. The method of obtaining information respective to an individual using an automating transaction machine from a personal identification reference as recited in claim 1, further comprising steps of:
presenting a banknote to said image acquisition device;
obtaining a digital image of said banknote, wherein the step is accomplished by said image acquisition device integrated into said banknote acceptor;
processing said banknote based upon a captured image of said banknote in accordance with a set of instructions.

4. The method of obtaining information respective to an individual using an automating transaction machine from a personal identification reference as recited in claim 3, wherein said image acquisition device is located within a housing of said banknote validator and accessible through an insertion slot of said banknote validator housing, further comprising steps of:
inserting said personal identification reference into said insertion slot to present said personal identification reference to said image acquisition device; and
inserting said banknote into said insertion slot to present said personal identification reference to said image acquisition device.

5. The method of obtaining information respective to an individual using an automating transaction machine from a personal identification reference as recited in claim 1, wherein said image acquisition device is located within a housing of said banknote validator and accessible through an insertion slot of said banknote validator housing, further comprising a step of:
inserting said personal identification reference into said insertion slot to present said personal identification reference to said image acquisition device.

6. The method of obtaining information respective to an individual using an automating transaction machine from a personal identification reference as recited in claim 1, further comprising a step of:
validating said personal identification reference by comparing information obtained from said personal identification reference with information obtained by a server comprising a database of known personal identification references.

7. The method of obtaining information respective to an individual using an automating transaction machine from a personal identification reference as recited in claim 1, further comprising a step of:
determining if an individual associated with the personal identification reference is restricted from using said automated machine by interrogating a user restrictions database.

8. The method of obtaining information respective to an individual using an automating transaction machine from a personal identification reference as recited in claim 1, further comprising a step of:
creating an association between said personal identification reference and a secondary reference, wherein said secondary reference is at least one of:
a corporate related account,
a facility related account,
a user reward system,
a gaming player's card,
a financial account,
a financial card,
an ATM card,
a credit card,
an electronic wallet,
an electronic account,
an e-commerce account, and
another personal identification reference.

9. The method of obtaining information respective to an individual using an automating transaction machine from a personal identification reference as recited in claim 8, further comprising a step of:
accomplishing a transaction using said secondary reference, wherein said secondary reference is determined by said association between said personal identification reference and said secondary reference.

10. A method of obtaining information respective to an individual using an automating transaction machine from a personal identification reference, the method comprising steps of:
presenting the personal identification reference to an image acquisition device integrated within a banknote acceptor of an automated machine having an automated financial transaction system integrated therein, the banknote acceptor comprising:
an insertion slot defined between a lower transport element and an upper transport element,
a microprocessor in signal communication with the image acquisition device,
a signal communication interface providing signal communication between the microprocessor and at least one personal identification database server containing a personal identification database; and
obtaining a digital image of said personal identification reference, wherein the step is accomplished by the image acquisition device integrated into the banknote acceptor;
converting at least a portion of said digital image into at least one character string, wherein said converting step is accomplished by said microprocessor in accordance with a set of associated conversion instructions;
authenticating said personal identification reference by at least one of:
comparing said at least one character string with information obtained from an authentication database,
extracting a photograph from said digital image of said personal identification reference and comparing said photograph with a photograph obtained from said authentication database, and
comparing said photograph extracted from said digital image of said personal identification reference with a photographic image obtained from a digital camera integrated into said automated machine.

11. The method of obtaining information respective to an individual using an automating transaction machine from a personal identification reference as recited in claim 10, further comprising steps of:
storing information obtained from the digital image of the personal identification reference in the personal identification database located on one or more of the at least one personal identification database servers.

12. The method of obtaining information respective to an individual using an automating transaction machine from a personal identification reference as recited in claim 11, further comprising steps of:
storing information identifying which process was utilized to authenticate said personal identification reference.

13. The method of obtaining information respective to an individual using an automating transaction machine from a personal identification reference as recited in claim 10, further comprising steps of:
presenting a banknote to said image acquisition device;
obtaining a digital image of said banknote, wherein the step is accomplished by said image acquisition device integrated into said banknote acceptor;
processing said banknote based upon a captured image of said banknote in accordance with a set of instructions.

14. The method of obtaining information respective to an individual using an automating transaction machine from a personal identification reference as recited in claim 10, further comprising a step of:
determining if an individual associated with the personal identification reference is restricted from using said automated machine by interrogating a user restrictions database.

15. The method of obtaining information respective to an individual using an automating transaction machine from a personal identification reference as recited in claim 10, further comprising a step of:
creating an association between said personal identification reference and a secondary reference, wherein said secondary reference is at least one of:
a corporate related account,
a facility related account,
a user reward system,
a gaming player's card,
a financial account,
a financial card,
an ATM card,
a credit card,
an electronic wallet,
an electronic account,
an e-commerce account, and
another personal identification reference.

16. The method of obtaining information respective to an individual using an automating transaction machine from a personal identification reference as recited in claim 15, further comprising a step of:
accomplishing a transaction using said secondary reference, wherein said secondary reference is determined by said association between said personal identification reference and said secondary reference.

17. A method of obtaining information respective to an individual using an automating transaction machine from a personal identification reference, the method comprising steps of:
presenting the personal identification reference to an image acquisition device integrated within a banknote acceptor of an automated machine having an automated financial transaction system integrated therein, the banknote acceptor comprising:
an insertion slot defined between a lower transport element and an upper transport element,
a microprocessor in signal communication with the image acquisition device,
a signal communication interface providing signal communication between the microprocessor and at least one personal identification database server containing a personal identification database; and
obtaining a digital image of said personal identification reference, wherein the step is accomplished by the image acquisition device integrated into the banknote acceptor;
converting at least a portion of said digital image into at least one character string, wherein said converting step is accomplished by said microprocessor in accordance with a set of associated conversion instructions;
authenticating said personal identification reference; and
proceeding in accordance with one of the following conditions:
when said personal identification reference is authenticated, grant an individual associated with said personal identification reference use of said automated machine, and
when said personal identification reference is not authenticated, deny said individual associated with said personal identification reference use of said automated machine.

18. The method of obtaining information respective to an individual using an automating transaction machine from a personal identification reference as recited in claim 17, further comprising a step of:
authenticating said personal identification reference by at least one of:
converting at least a portion of said digital image into at least one character string, wherein said converting step is accomplished by said microprocessor in accordance with a set of associated conversion instructions and comparing said at least one character string with information obtained from an authentication database,
extracting a photograph from said digital image of said personal identification reference and comparing said photograph with a photograph obtained from said authentication database, and
comparing said photograph extracted from said digital image of said personal identification reference with a photographic image obtained from a digital camera integrated into said automated machine.

19. The method of obtaining information respective to an individual using an automating transaction machine from a personal identification reference as recited in claim 17, wherein said image acquisition device is located within a housing of said banknote validator and accessible through an insertion slot of said banknote validator housing, further comprising steps of:
inserting said personal identification reference into said insertion slot to present said personal identification reference to said image acquisition device; and
inserting said banknote into said insertion slot to present said personal identification reference to said image acquisition device.

20. The method of obtaining information respective to an individual using an automating transaction machine from a personal identification reference as recited in claim 17, further comprising a step of:
determining if an individual associated with the personal identification reference is restricted from using said automated machine by interrogating a user restrictions database.

21. The method of obtaining information respective to an individual using an automating transaction machine from a personal identification reference as recited in claim 17, further comprising a step of:
creating an association between said personal identification reference and a secondary reference, wherein said secondary reference is at least one of:
a corporate related account,
a facility related account,
a user reward system,
a gaming player's card,
a financial account,
a financial card,
an ATM card,
a credit card,
an electronic wallet,
an electronic account,
an e-commerce account, and
another personal identification reference.

22. The method of obtaining information respective to an individual using an automating transaction machine from a personal identification reference as recited in claim 21, further comprising a step of:
accomplishing a transaction using said secondary reference, wherein said secondary reference is determined by said association between said personal identification reference and said secondary reference.
